(19) United States
(12) Patent Application Publication
(10) Pub. No.: US 2018/0320426 A1
(43) Pub. Date: Nov. 8, 2018

(54) HIDDEN EASY-TO-CLEAN SHOWER DOOR SLIDING DEVICE

(71) Applicant: Ideal Sanitary Ware Co., Ltd., Foshan (CN)

(72) Inventor: Wuxiang Wei, Foshan (CN)

(73) Assignee: Ideal Sanitary Ware Co., Ltd., Foshan (CN)

(21) Appl. No.: 15/540,204

(22) PCT Filed: Jan. 29, 2016
(86) PCT No.: PCT/CN2016/072682

§ 371 Date: Jun. 27, 2017

(51) Int. Cl. E05D 15/06; A47K 3/34

(52) U.S. Cl. CPC E05D 15/0665; E05Y 2600/52; E05Y 2900/114; A47K 3/34

(57) ABSTRACT

The present invention discloses a hidden easy-to-clean shower door sliding device including a rail with a sliding channel, a pulley seat installed on a movable door sheet, and a pulley bracket provided with a pulley. The pulley bracket and the rail form relative sliding fit by rolling the pulley in the sliding channel. A first magnetic member is arranged on the pulley bracket, a second magnetic member is arranged on the pulley seat, and fixation or separation of the pulley bracket and the pulley seat is achieved through adsorption or separation of the first magnetic member and the second magnetic member.

### TECHNICAL FIELD

The present invention relates to the technical field of shower doors, and more particularly, to a shower door sliding device, especially to a shower door sliding device that can achieve hiding and is easy to clean.

### BACKGROUND ART

An existing sliding type shower door generally has upper and lower rails and a movable door sheet, where a sliding channel is arranged on one side of the rail, an upper pulley and a lower pulley are installed on the movable door sheet, the pulleys may slide on the rails, and during a process in which the movable door sheet slides along the rails, there is a certain distance between the movable door sheet and the rails. On the one hand, because the sliding channel is located on the side of the rails, a user may see the sliding channel of the rails and the sliding pulleys when looking out from the shower door, thus affecting aesthetics; on the other hand, the shower door may need to be cleaned in a timely manner, while in the structure of an existing shower door, separation between the rails and movable door sheet is cumbersome, so that it is relatively difficult to carry out removal work of sundries and dirt in the rails and movable door sheet.

### SUMMARY OF THE INVENTION

The technical problem to be solved by the present invention is to provide a hidden easy-to-clean shower door sliding device capable of improving aesthetics and ease of use in view of the above mentioned drawbacks in the prior art.

To solve above technical problem, the present invention adopts the following technical solutions: a hidden easy-to-clean shower door sliding device is designed, which includes: a rail with a sliding channel, a pulley seat installed on a movable door sheet, and a pulley bracket provided with a pulley, where the pulley bracket and the rail form relative sliding fit by rolling the pulley in the sliding channel, where a first magnetic member is arranged on the pulley bracket, a second magnetic member is arranged on the pulley seat, and fixation or separation of the pulley bracket and the pulley seat is achieved through adsorption or separation of the first magnetic member and the second magnetic member.

In a further technical solution, an interior of the rail may be provide with a sliding channel formed by a substantially C-sectioned groove wall and used for the pulley to roll therein, the lower part of one side of the sliding channel has an opening, a decorative plate for hiding the sliding channel and the pulley is arranged on the outer side of the sliding channel, an open cavity is arranged on the upper part of the sliding channel, and a screw hole is arranged on an internal corner between an outer wall and a bottom wall of the rail.

In a further technical solution, the pulley bracket includes a pulley bracket body and a bending plate, the first magnetic member is installed on one side of the pulley bracket body, the bending plate extends upwardly from one side of the bottom of the pulley bracket body, and a screw hole is arranged on the top of the bending plate to install the pulley; and the pulley is arranged within the sliding channel by the pulley bracket via the bending plate.

In a further technical solution, the pulley bracket body may be substantially plate-shaped, a first blind hole is arranged on the back side of the pulley bracket body, the first magnetic member is installed within the first blind hole, a baffle plate extends out from an edge of the pulley bracket body along a direction away from the bending plate, the baffle plate and the pulley bracket body form an accommodating chamber for accommodating the pulley seat, and a size of the accommodating chamber is adapted to that of the pulley seat.

In a further technical solution, the pulley seat may include a pulley seat body plate, a second blind hole is arranged on the back side of the pulley seat body plate, and the second magnetic member is installed within the second blind hole; a screw hole is arranged on the pulley seat body plate, and the pulley seat is fixed to the movable door sheet via a screw; a first baffle plate extends out from the lower part of the pulley seat body plate in a direction perpendicular to a plane at which the body plate is located, and the first baffle plate is in contact with an edge of the movable door sheet, to prevent the pulley seat from rotating relative to the movable door sheet; and guide parts are arranged on both sides of the pulley seat body plate.

In a further technical solution, the device may further include a pulley seat fixing member, where the pulley seat is fixed to the movable door sheet by cooperating with the pulley seat fixing member, the pulley seat fixing member includes a fixing member body plate, and a screw hole is formed on the fixing member body plate, the pulley seat fixing member is installed on the movable door sheet via a screw, a second baffle plate extends out from the lower part of the fixing member body plate in a direction perpendicular to a plane at which the fixing member body plate is located, and the second baffle plate is in contact with an edge of the movable door sheet, to prevent the pulley seat fixing member from rotating relative to the movable door sheet.

In a further technical solution, a decorative cap may be disposed on an exterior of the pulley seat fixing member.

In a further technical solution, the pulley seat is fixed to the movable door sheet in an adhesive manner.

In a further technical solution, a plurality of first magnetic members and a plurality of second magnetic members can be arranged respectively.

It may be seen from the above solutions that the shower door sliding device of the present invention may achieve fixation between the pulley bracket and the pulley seat through magnetic attraction. When it needs to be cleaned, only an external force may be used to separate magnetic members, then the pulley bracket and the pulley seat are separated, thereby achieving separation of the movable door sheet and the rail; after cleaning, the external force is removed, the movable door sheet reverts back under self-weight action to achieve contact between the pulley bracket and the pulley seat, and fixation between them under magnetic force action may be achieved again, operation is simple and convenient, and the sliding channel of the rail and the pulleys can be hidden, so that appearance is aesthetically pleasing.

### BRIEF DESCRIPTION OF THE DRAWINGS

FIG. 1 is a schematic view of an application position of a shower door sliding device in a shower door of the present invention.

FIG. 2 is an exploded schematic view of components of a shower door sliding device of an embodiment of the present invention.

FIG. 3 is a structural schematic view of a rail of the shower door sliding device shown in FIG. 2.

FIG. 4a is a schematic view of a pulley bracket of the shower door sliding device shown in FIG. 2, and FIG. 4b is a schematic view of the back side of the pulley bracket body shown in FIG. 4a.

FIG. 5a and FIG. 5b are schematic views of the front side and back side of the pulley seat of the shower door sliding device shown in FIG. 2, respectively.

FIG. 6 is a schematic view in which the pulley seat of the shower door sliding device shown in FIG. 2 is fixed to the movable door sheet, and respectively shows the pulley seat fixing member and the front side and back side of the decorative cap.

FIG. 7 is a schematic view in which the pulley bracket of the shower door sliding device shown in FIG. 2 is fixed to the pulley seat.

FIG. 8 is a schematic perspective view in which the movable door sheet of the shower door sliding device shown in FIG. 2 slides along the rail.

FIG. 9 is a longitudinal view in which the movable door sheet of the shower door sliding device shown in FIG. 2 slides along the rail.

FIG. 10 is a schematic perspective view in which the movable door sheet of the shower door sliding device shown in FIG. 2 is separated from the rail.

FIG. 11 is a longitudinal view in which the movable door sheet of the shower door sliding device shown in FIG. 2 is separated from the rail.

### DETAILED DESCRIPTION OF THE INVENTION

Embodiments of the present invention may be described in detail below, examples thereof may be illustrate with reference to the accompanying drawings and described in the context, and other element having no influence on the protection scope of claims of the present application is omitted in the above accompanying drawings. It should be noted that although the present invention will be described with reference to exemplary embodiments, it should be understood that the present invention is not limited to these exemplary embodiments. On the contrary, the present invention includes not only these embodiments, but also various variations and modifications.

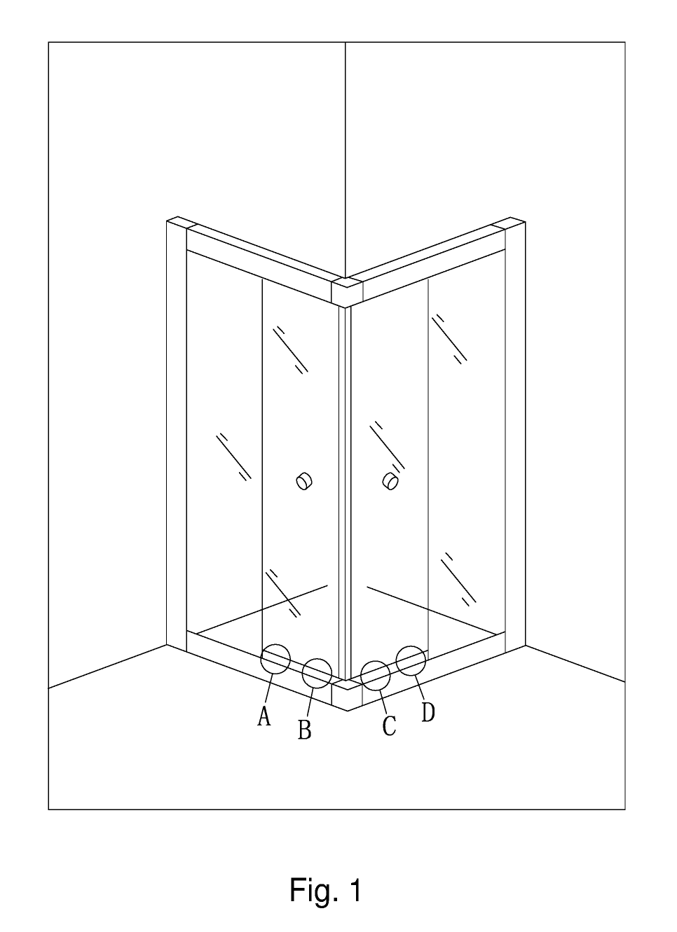

Referring to FIG. 1, which shows an application position of a shower door sliding device in a shower door of the present invention, such as A, B, C, and D.

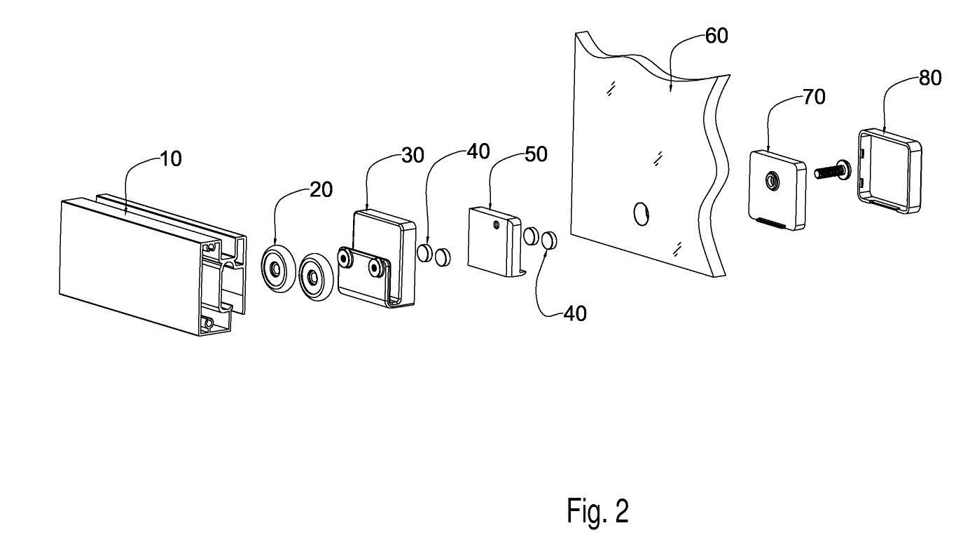

Referring to FIG. 2, an embodiment of the present invention includes a rail 10, a pulley 20, a pulley bracket 30, magnetic members 40, a pulley seat 50, a pulley seat fixing member 70 and a decorative cap 80 and the like, wherein the pulley bracket 30 is slidably arranged on the rail 10 via the pulley 20, the pulley seat 50 cooperates with the pulley seat fixing member 70 to be fixed to a movable door sheet 60, a plurality of the magnetic members 40 may be arranged, the pulley bracket 30 and the pulley seat 50 are respectively provided with the magnetic members 40, and the movable door sheet 60 and the pulley bracket 30 may be secured to each other by magnetic attraction of the magnetic members 40, thereby ensuring linearly relative sliding of the movable door sheet 60 along the rail 10. An external force acts on the movable door sheet 60 to separate the magnetic members 40, so as to achieve separation between the movable door sheet 60 and the rail 10.

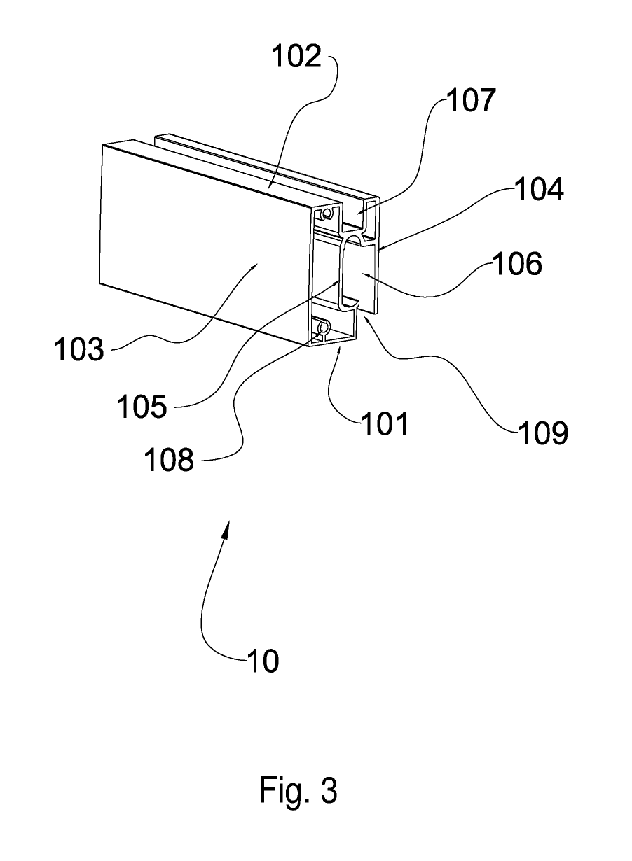

Referring to FIG. 3, an interior of the rail 10 is a sliding channel 106 formed by a substantially C-sectioned groove wall 105 and used for the pulley 20 to roll therein, the lower part of one side of the sliding channel 106 has an opening 109, a decorative plate 104 is arranged on the outer side of the sliding channel 106, an open cavity 107 is arranged on the upper part of the sliding channel 106, and other sealing members for the movable door sheet can be installed. A screw hole 108 is arranged on an internal corner between an outer wall 103 and a bottom wall 101 of the rail 10.

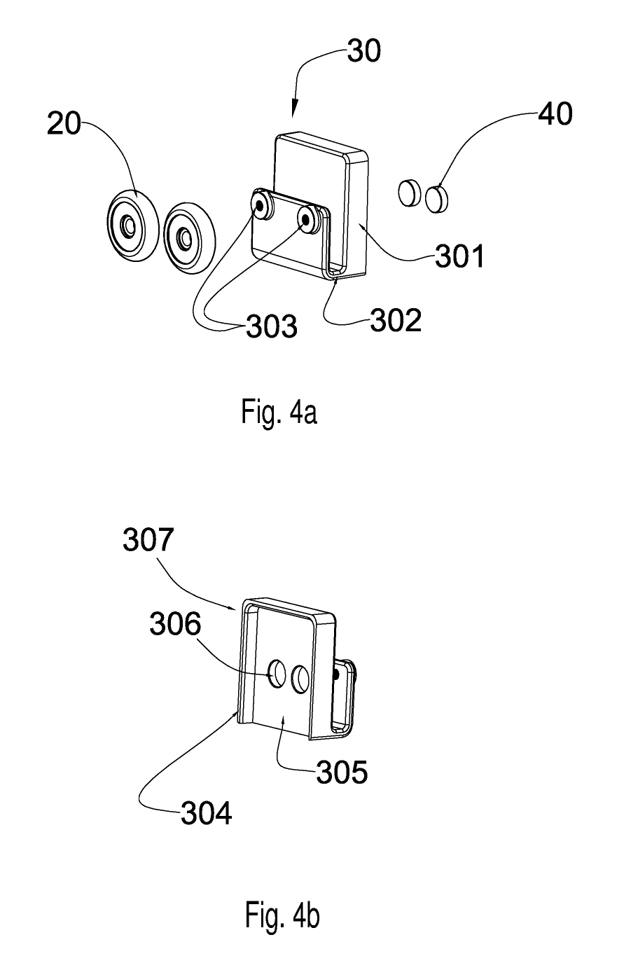

As shown in FIG. 4a, the magnetic member 40 is installed on one side of a body 301 of the pulley bracket 30, a bending plate 302 extends upwardly from one side of the bottom of the body 301, and screw holes 303 are arranged on the top of the bending plate 302 to install the pulleys 20. The pulley bracket 30 gets into the sliding channel 106 from the opening 109 by using the bending plate 302, and sets the pulleys 20 into the sliding channel 106. The decorative plate 104 hides the sliding channel 106 and the pulleys 20, which achieves aesthetic effects.

As shown in FIG. 4b, the pulley bracket 30 has a substantially plate-shaped body 307, more than one (there are two in the embodiment) blind holes 306 are arranged on the back side of the body 307, the magnetic members 40 are installed within the blind holes 306, a baffle plate 304 extends out from an edge of the body 307 along a direction away from the bending plate 302, the baffle plate 304 and the body 307 form an accommodating chamber 305, and a size of the accommodating chamber 305 is adapted to that of the pulley seat 50 to accommodate the pulley seat 50.

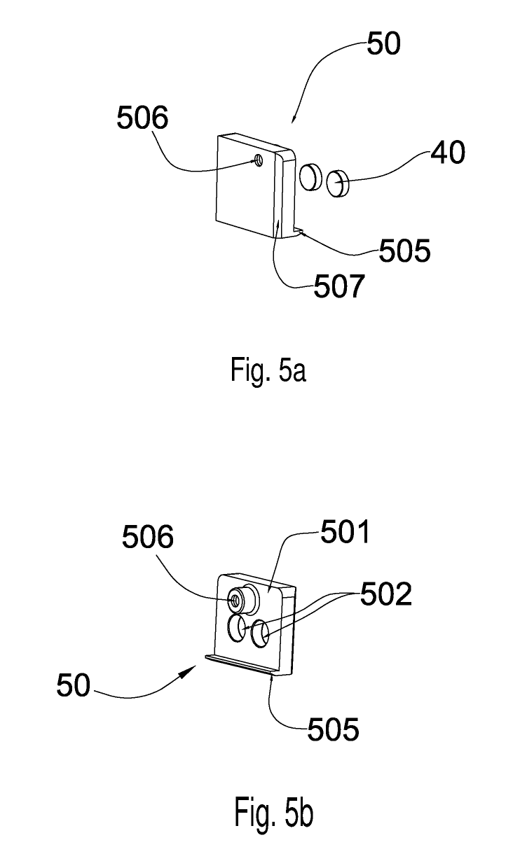

As shown in FIG. 5a and FIG. 5b, the pulley seat 50 has a body plate 501, more than one (there are two in the embodiment) blind holes 502 are arranged on the back side of the body plate 501, the magnetic members 40 are arranged within the blind holes 502, a screw hole 506 is arranged on the body plate 501, and the pulley seat 50 is fixed to the movable door 60 by a screw (not shown), a baffle plate 505 extends out from the lower part of the body plate 501 in a direction perpendicular to a plane at which the body plate 501 is located, and the baffle plate 505 is in contact with an edge of the movable door sheet 60, to prevent the pulley seat 50 from rotating relative to the movable door sheet 60. Guide parts 507 are arranged on both sides of the body plate 501.

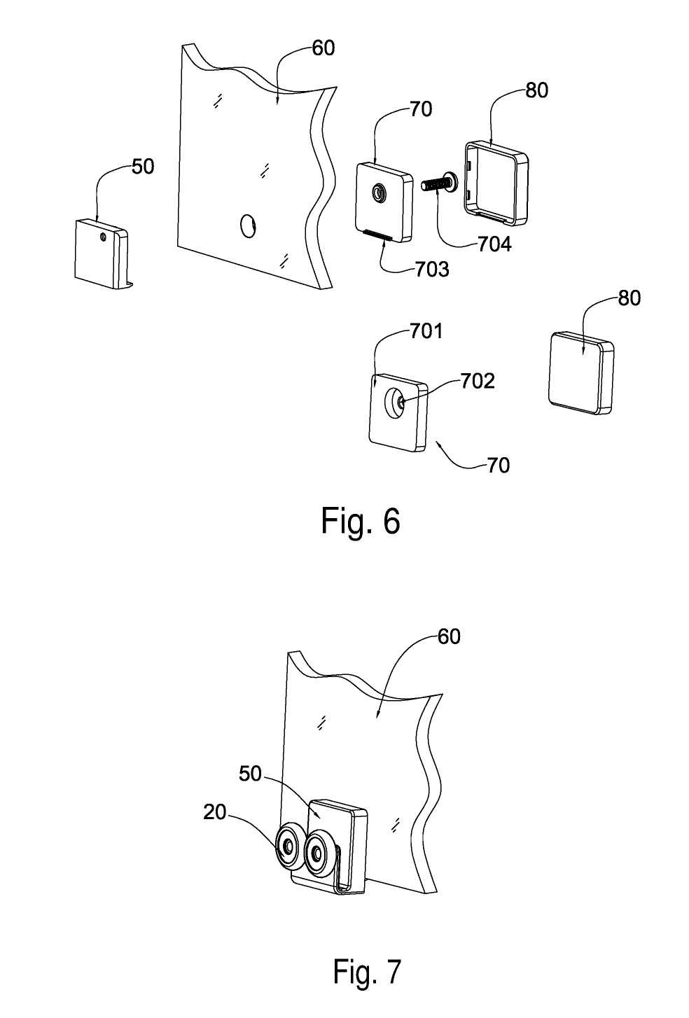

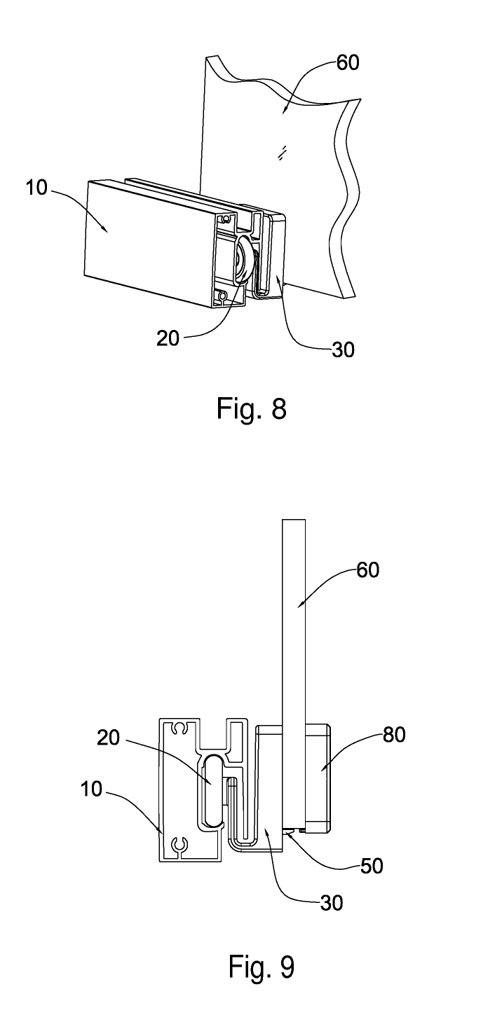

As shown in FIG. 6, the pulley seat fixing member 70 has a body plate 701, a screw hole 702 is formed on the body plate 701, and the pulley seat fixing member 70 is fixed to the movable door 60 by a screw 704, a baffle plate 703 extends out from the lower part of the body plate 701 in a direction perpendicular to a plane at which the body plate 701 is located, and the baffle plate 703 is in contact with an edge of the movable door sheet 60, to prevent the pulley seat fixing member 70 from rotating relative to the movable door sheet 60. A decorative cap 80 may be disposed on an exterior of the pulley seat fixing member 70. It should be stated that the pulley seat fixing member 70 and the decorative cap 80 are not essential, for example, the pulley seat 50 can be fixed to the movable door sheet 60 in an adhesive manner.

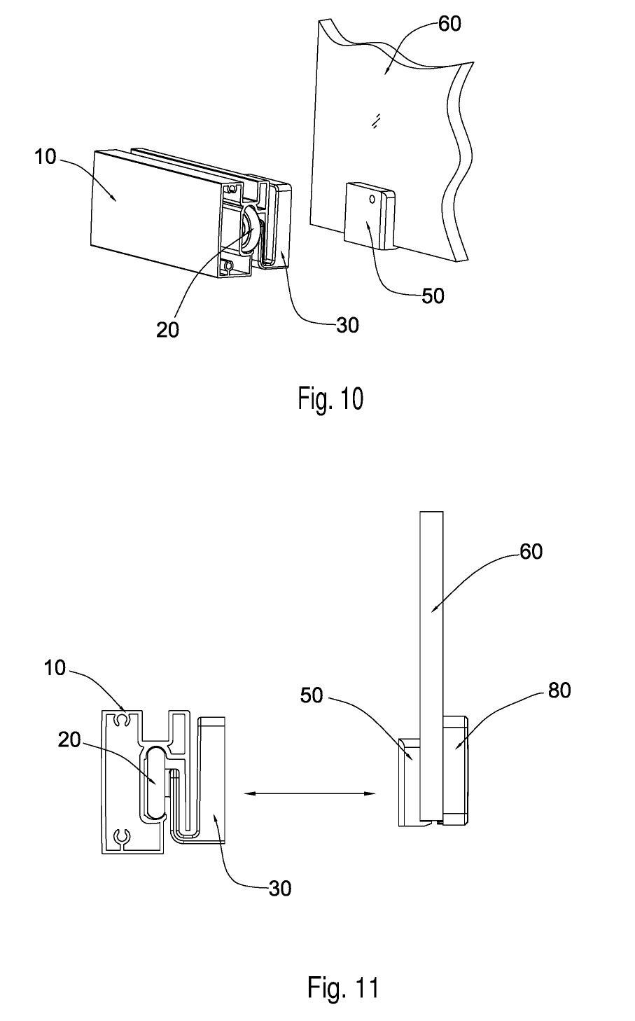

As shown in FIG. 10 and FIG. 11, when cleaning is required, only an external force may be used to separate magnetic members 40, then the pulley bracket 30 and the pulley seat 50 are separated, thereby achieving separation of the movable door sheet 60 and the rail 10. After cleaning, the external force is removed, and the movable door sheet 60 reverts back under self-weight action to achieve contact between the pulley bracket 30 and the pulley seat 50, and fixation between them under magnetic force action may be achieved again, operation is simple and convenient, and the sliding channel of the rail and the pulleys can be hidden, so that appearance is aesthetically pleasing.

The foregoing descriptions are merely preferred embodiments of the invention. It should be noted that various modifications and variations made by those skilled in the art without departing from the conception of the present invention shall still fall within the protection scope of the present invention.

### INDUSTRIAL APPLICABILITY

The hidden easy-to-clean shower door sliding device of the present invention can be manufactured and used in industry; therefore the present invention possesses industrial applicability.

1. A hidden easy-to-clean shower door sliding device, comprising:
a rail with a sliding channel;
a pulley seat installed on a movable door sheet; and
a pulley bracket provided with a pulley, wherein the pulley bracket and the rail form relative sliding fit by rolling the pulley in the sliding channel;
wherein a first magnetic member is arranged on the pulley bracket, a second magnetic member is arranged on the pulley seat, and fixation or separation of the pulley bracket and the pulley seat is achieved through adsorption or separation of the first magnetic member and the second magnetic member.

2. The shower door sliding device according to claim 1, wherein an interior of the rail is provide with a sliding channel formed by a substantially C-sectioned groove wall and used for the pulley to roll therein, a lower part of one side of the sliding channel has an opening, a decorative plate for hiding the sliding channel and the pulley is arranged on an outer side of the sliding channel, an open cavity is arranged on an upper part of the sliding channel, and a screw hole is arranged on an internal corner between an outer wall and a bottom wall of the rail.

3. The shower door sliding device according to claim 1, wherein the pulley bracket comprises a pulley bracket body and a bending plate, the first magnetic member is installed on one side of the pulley bracket body, the bending plate extends upwardly from one side of the bottom of the pulley bracket body, and a screw hole is arranged on a top of the bending plate to install the pulley; and the pulley is arranged within the sliding channel by the pulley bracket via the bending plate.

4. The shower door sliding device according to claim 3, wherein the pulley bracket body is substantially plate-shaped, a first blind hole is arranged on a back side of the pulley bracket body, the first magnetic member is installed within the first blind hole, a baffle plate extends out from an edge of the pulley bracket body along a direction away from the bending plate, the baffle plate and the pulley bracket body form an accommodating chamber for accommodating the pulley seat, and a size of the accommodating chamber is adapted to that of the pulley seat.

5. The shower door sliding device according to claim 1, wherein the pulley seat comprises a pulley seat body plate, a second blind hole is arranged on the back side of the pulley seat body plate, and the second magnetic member is installed within the second blind hole; a screw hole is arranged on the pulley seat body plate, and the pulley seat is fixed to the movable door sheet via a screw; and a first baffle plate extends out from a lower part of the pulley seat body plate in a direction perpendicular to a plane at which the body plate is located, and the first baffle plate is in contact with an edge of the movable door sheet, to prevent the pulley seat from rotating relative to the movable door sheet.

6. The shower door sliding device according to claim 5, wherein guide parts are arranged on both sides of the pulley seat body plate.

7. The shower door sliding device according to claim 1, further comprising a pulley seat fixing member, wherein the pulley seat is fixed to the movable door sheet by cooperating with the pulley seat fixing member, the pulley seat fixing member comprises a fixing member body plate, and a screw hole is formed on the fixing member body plate, the pulley seat fixing member is installed on the movable door sheet via a screw, a second baffle plate extends out from a lower part of the fixing member body plate in a direction perpendicular to a plane at which the fixing member body plate is located, and the second baffle plate is in contact with an edge of the movable door sheet, to prevent the pulley seat fixing member from rotating relative to the movable door sheet.

8. The shower door sliding device according to claim 7, wherein a decorative cap covers an exterior of the pulley seat fixing member.

9. The shower door sliding device according to claim 1, wherein the pulley seat is adhesively fixed to the movable door sheet.

10. The shower door sliding device according to claim 1, wherein a plurality of first magnetic members and a plurality of second magnetic members are arranged respectively.
